(19) United States
(12) Patent Application Publication
(10) Pub. No.: US 2017/0300847 A1
(43) Pub. Date: Oct. 19, 2017

(54) Systems and Methods for Thermal Monitoring in a Retail Facility

(71) Applicant: Wal-Mart Stores, Inc., Bentonville, AR (US)

(72) Inventors: Nicholaus A. Jones, Fayetteville, AR (US); Robert J. Taylor, Rogers, AR (US); Aaron J. Vasgaard, Rogers, AR (US); Matthew A. Jones, Bentonville, AR (US)

(21) Appl. No.: 15/486,875

(22) Filed: Apr. 13, 2017

Related U.S. Application Data
(60) Provisional application No. 62/323,087, filed on Apr. 15, 2016.

(51) Int. Cl. G06Q 10/06; F24F 11/00; G06Q 20/20

(52) U.S. Cl. CPC G06Q 10/063114; F24F 11/006; F24F 11/0086; F24F 11/0034; F24F 2011/0063; F24F 2011/0073; F24F 2011/0091; G06Q 20/20; F24F 2011/0064

(57) ABSTRACT

Systems, apparatuses and methods are provided herein for thermal monitoring in a retail facility. A system for thermal monitoring in a retail facility comprises: a thermal sensor positioned in a predetermined location of a portion of the retail facility; a database for storing thermal images and thermal data obtained from the thermal sensor and known thermal profiles; and a control circuit configured to identify a thermal image obtained from the thermal sensor that deviates from an expected baseline thermal profile for the portion of the retail facility; and compare the thermal image to the known thermal profiles to determine at least one of estimated occupancy, temperature control unit efficiency, temperature control unit operation and whether a temperature-sensitive retail item has been abandoned.

### RELATED APPLICATION

This application claims the benefit of U.S. Provisional Application No. 62/323,087, filed Apr. 15, 2016, which is incorporated herein by reference in its entirety.

### TECHNICAL FIELD

This invention relates generally to thermal monitoring in a retail facility. In particular, the present invention relates to a systems and methods for thermal monitoring in a retail facility using thermal imaging techniques.

### BACKGROUND

In modern retail environments, there is a need to improve the customer experience. A positive customer experience may be based on, for example, adequately stocked items on shelves, fast customer service, and clean, unobstructed aisles. Occupancy in various areas of a retail facility may often fluctuate due to for example, low shelf inventory, low levels of service, and obstructions or spills in aisles of the retail facility. These issues may cause customers to linger in a specific area of the retail facility, or to avoid another area of the retail facility, impacting the customer experience. Thus, there is a need in retail environments to detect fluctuations in occupancy in various areas of a retail facility, which may correlate to one or more problems that may cause a negative customer experience, so that any problems that may detract from the customer experience may be resolved quickly. This occupancy data may also be useful for mapping customer traffic patterns and for marketing purposes.

There is also a need in modern retail environments to be able to quickly detect fluctuations in temperature of temperature-sensitive items to determine, for example, whether such items have been abandoned in ambient-temperature areas of the retail facility or are otherwise at risk for spoiling due to deviations from recommended temperatures. For example, a customer may place a temperature-sensitive item in their cart, such as, for example, a refrigerated product or a heated cafeteria-style food item, and, for various reasons, may abandon the item in an ambient-temperature area of the store, such as, for example, an aisle or shelf. In such as case, if a worker is not quickly alerted to the presence of the item, the item may spoil, resulting in a loss to the retailer. Thus, there is a need to be able to quickly detect and identify abandoned temperature-sensitive retail items and to alert a worker to attend to the abandoned item so that it does not spoil. In another example, perishable products typically kept at recommended temperatures in a cooler or warmer, such as food products, may be subject to spoiling if the cooler or warmer begins to fail or is otherwise compromised or unfit for use.

As such, it is also often desirable in modern retail environments to quickly detect the loss of function of various temperature control units such as, for example, coolers, refrigerators, warming units, and heating, ventilating, and air conditioning (“HVAC”) units, located throughout the retail facility. However, failure of such systems is often discovered after the system has already stopped functioning as required. For example, the failure of a refrigerator is often discovered only after the cooling function fails and the temperature inside the refrigerator begins to rise above a threshold temperature, which may result in spoiled product and losses for the retailer.

Often times, temperature control units, such as, for example, coolers, refrigerators, warming units, and HVAC units, experience a decrease in efficiency prior to failure, which may cause an increase in temperature directly surrounding the temperature control unit as the unit tries to maintain its programmed temperature. For example, a refrigerator that is approaching failure and/or is losing cooling efficiency may begin to emit additional heat from the exterior of the unit due to the increased work necessary to maintain the required cold temperature inside the refrigerator. Thus, there is a need in modern retail environments to be able to detect fluctuations in temperatures emitted from the exterior of a temperature control unit in order to detect loss of efficiency and/or to predict imminent failure of the system prior to actual failure. In such a case, a worker can be alerted to the condition of the unit prior to actual failure of the unit.

### BRIEF DESCRIPTION OF THE DRAWINGS

Disclosed herein are embodiments of systems, apparatuses and methods pertaining to detecting occupancy in a retail facility. This description includes drawings, wherein:

FIG. 1 is a block diagram of a system in accordance with several embodiments.

FIG. 2 is a flow diagram of a method in accordance with several embodiments.

FIG. 3 is an illustration of an area of a retail facility in accordance with several embodiments.

FIG. 4 is an illustration of a thermal monitoring scenario of a cooling system.

FIG. 5 is an illustration of a thermal monitoring scenario of a cooling system.

FIG. 6 is an illustration of a thermal monitoring scenario of a cooling system.

FIG. 7 is an illustration of a thermal monitoring scenario of a cooling system.

FIG. 8 is an illustration of a thermal monitoring scenario of a cooling system.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful for thermal monitoring in a retail facility. Embodiments may include a control circuit coupled to a thermal sensor and a database. The thermal sensor may be positioned in a predetermined location of a portion of the retail facility where thermal monitoring is desired. The database may store thermal images and/or thermal data obtained from the thermal sensor and may also store known thermal profiles correlating to baseline conditions, occupancy, temperature control unit efficiency, temperature control unit operation, and retail stock. In some embodiments, the system may identify a thermal image obtained from the thermal sensor that deviates from an expected baseline thermal profile for the portion of the retail facility and compare the thermal image to the known thermal profiles to determine at least one of estimated occupancy, temperature control unit efficiency, temperature control unit operation, and whether a temperature-sensitive retail item has been abandoned.

In some embodiments, the thermal sensor may comprise an infrared sensor. In some embodiments, the thermal sensor may comprise an infrared camera, such as, for example, a forward looking infrared (FLIR) camera. The thermal sensor may be positioned at, for example, an end of an aisle of the retail facility. In some embodiments, the thermal sensor may be positioned above the portion of the retail facility such that the infrared sensor is inside the retail facility.

In some embodiments, the control circuit may be further configured to alert a worker when a temperature control unit is determined to be failing or is otherwise compromised. The temperature control unit may be determined to be failing when a thermal image of the temperature control unit indicates a warmer temperature than expected based on a known thermal profile of the temperature control unit. In such a case, the control circuit may match the thermal image of the temperature control unit with a known thermal profile correlating to a failure or a pre-failure state of the unit. In other embodiments, failure or loss of function may be detected or predicted when a thermal image of a cooler containing cooled products, such as, for example dairy products, indicates a higher temperature than expected, or a warming unit containing warmed products, such as, for example, ready-to-eat prepared foods, indicates a lower temperature than expected.

In other embodiments, the control circuit may be further configured to alert a worker when a temperature-sensitive retail item is determined to be abandoned. A temperature-sensitive retail item may be determined to be abandoned when the thermal image obtained for a given area or zone of the retail facility indicates a colder or warmer temperature than expected based on the baseline thermal profile of the portion of the retail facility.

Some embodiments further include one or more point of sale units that transmit point of sale data for the retail facility to the control circuit. The point of sale data may also be stored in the database. In cases where the system determines estimated occupancy of a portion of the retail facility, the system may compare the estimated occupancy to the point of sale data to determine if the estimated occupancy of the portion of the retail facility is justified by the point of sale data. The estimated occupancy may be deemed to be justified when the point of sale data is higher than a predetermined value. If the estimated occupancy of the portion of the retail facility is determined not to be justified by the point of sale data, the system may alert a store worker to attend to the portion of the retail facility. If the estimated occupancy of the portion of the retail facility is determined to be justified by the point of sale data, a marketing associate may be notified.

In some embodiments, the system may estimate the dwell time of customers in the retail facility by determining the duration that the estimated occupancy of the portion of the retail facility remains above the predetermined value. When the dwell time is longer than a specific duration, the system may alert a worker to attend to the portion of the retail facility. In some cases, a higher than expected dwell time may correlate to a low level of service such that the dwell time is inversely proportional to the level of service in the portion of the retail facility. Data relating to dwell time may also be useful for determining customer shopping patterns.

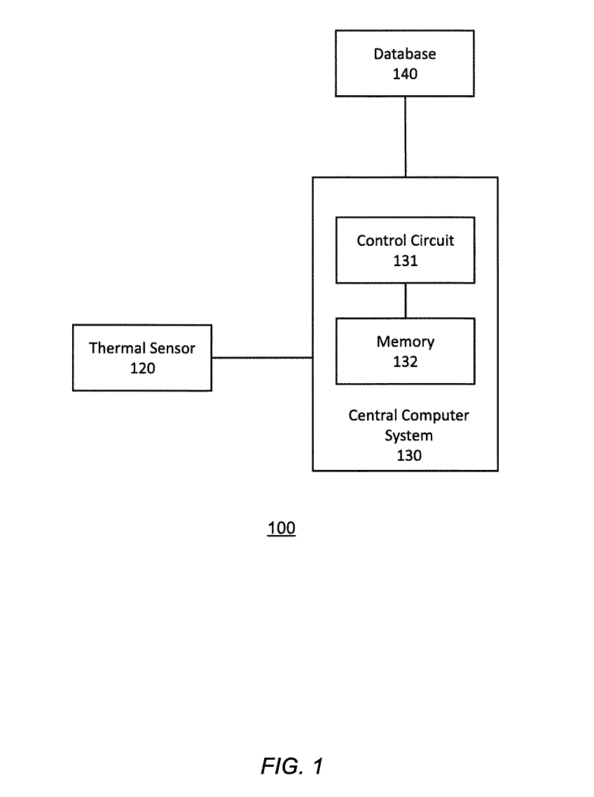

FIG. 1 illustrates an embodiment of a system for detecting occupancy of a retail facility. The system 100 includes a central computer system 130, a database 140, and a thermal sensor 120. The thermal sensor 120 may be configured to detect changes in ambient temperature due to, for example, heat emitted by customers present in the portion of the retail facility, heat emitted by temperature control units experiencing reduced efficiency/and or are nearing failure, changes in the thermal profile of a temperature control unit, such as a cooler or a warming unit, indicating a deviation from a recommended temperature range for the given perishable products, and changes in temperature due to perishable (hot or cold) retail item being abandoned or left in an incompatible portion of the retail facility.

The thermal sensor 120 may generally be configured to detect a heat source in the retail facility and transmit a thermal image and/or thermal data to the central computer system 130. The thermal sensor may be any sensor that is suitable for detecting a heat source. In some embodiments, the thermal sensor may be an infrared sensor. The infrared sensor may be, for example, a passive infrared sensor, a thermal imager, or any other sensor that detects thermal radiation, electromagnetic radiation, infrared energy, or any other type of energy. In some embodiments, the thermal sensor may comprise an infrared camera, such as, for example, a forward looking infrared (FLIR) camera. In some embodiments, the thermal sensor 120 may be a thermal sensor array. In some embodiments, the system may comprise a plurality of thermal sensors and/or thermal sensor arrays be positioned throughout a retail facility.

In some embodiments, thermal sensor 120 may be a stationary thermal sensor installed in the retail facility. For example, the thermal sensor 120 may be installed in the celling, pillars, beams, modules, display shelves, etc. of a retail facility. In some embodiments, the thermal sensor 120 may be positioned at an end of an aisle in the retail facility. In some embodiments, the thermal sensor 120 may be a directional sensor in which the sensor has a specific field of view. The image obtained from each sensor having a specific field of view may cover a zone or area of the retail facility, or may cover multiple zones or areas of the retail facility. The directional thermal sensor may be coupled to a rotation apparatus configured to rotate the thermal sensor, allowing rotation of the field of view of the thermal sensor. In this configuration, thermal updates for a specific area, zone, or location are provided at each rotation past the specific location. In some embodiments, the thermal sensor 120 may be a stationary sensor and have a wide-angle view, which may allow continuous, real-time monitoring.

Database 140 generally comprises volatile and/or non-volatile computer readable storage memory device(s). While the database 140 is shown as a separate component from the memory 132 of the central computer system 130 in FIG. 1, in some embodiments, the database 140 and the memory 132 may be implemented with the same one or more memory devices. Database 140 may generally store the known thermal profiles for various zones or areas of the retail facility relating to, for example, baseline conditions, occupancy, temperature control unit efficiency, temperature control unit operation, and retail stock data. The known thermal profiles may be determined or obtained at a previous time based on validation and quality control studies. The database 140 may also store data such as, but not limited to, data used to calculate the baseline temperature, known thermal profiles, expected occupancy, temperature unit efficiency, temperature control unit operation, and dwell times for various zones or areas of the retail facility, as well as data related to retail items and their locations, worker profiles, and point of sale data.

The central computer system 130 may include a control circuit 131 and a memory 132 and may generally be any processor-based device such as one or more of a computer system, a server, a networked computer, a cloud-based server, etc. The control circuit 131 may comprise a central processing unit, a processor, a microprocessor, and the like. The control circuit 131 may be configured to execute computer readable instructions stored on the memory 132. The memory 132 may comprise volatile and/or non-volatile computer readable storage memory and have stored upon it a set of computer readable instructions which, when executed by the control circuit 131, causes the system to identify a thermal image obtained from the thermal sensor that deviates from an expected baseline thermal profile for the portion of the retail facility. The central computer system 130 may be coupled to the one or more thermal sensors 120 via a wired and/or wireless signal connections.

In some embodiments, the central computer system 130 may be configured to process the thermal image obtained from the thermal sensor 120 to determine if the thermal image obtained from the thermal sensor deviates from an expected baseline thermal profile for the area or zone in the field of view of the sensor. The central computer system 130 may then be configured to compare the obtained thermal image for the area or zone in the field of view of the sensor to the known thermal profiles for the area or zone in the field of view of the sensor. The known thermal profiles may correlate to estimated occupancy, temperature control unit efficiency, temperature control unit operation, and/or whether a temperature-sensitive retail item has been abandoned. The central computer system 130 then matches the obtained thermal image to a known thermal profile to determine at least one of estimated occupancy, temperature control unit efficiency, temperature control unit operation, and whether a temperature-sensitive retail item has been abandoned.

In a non-limiting example, a thermal sensor may obtain an image covering a given zone or area. The zone may contain an HVAC unit, a food warming unit or cooler, and/or an aisle of the retail facility. The central computer system 130 compares the obtained thermal image to stored known “baseline” thermal images for the zone or area to determine if the thermal image indicates a temperature deviation from a defined tolerance range. If the thermal image indicates a temperature deviation from a defined tolerance range, central computer system 130 compares the obtained thermal image to stored known thermal images correlating to various states of deviation for the given zone or area to determine the abnormal condition. For example, where the zone includes an HVAC unit, the obtained thermal image may match a thermal image indicating that the HVAC unit is nearing failure. Where the zone includes a food warming unit or a cooler, the obtained thermal image may match a known thermal image indicating that the cooler is abnormally warm or the warming unit is abnormally cool, indicating the possibility of food spoilage. The thermal image of the cooler or warming unit, which generally contains cooled or warmed perishable retail products, respectively, may also show changing temperatures of the products themselves in the units. Where the zone includes an aisle, the obtained thermal image may match a known thermal image indicating a defined occupancy in the aisle and/or may match a thermal image indicating a temperature-sensitive retail item may be present in the aisle when it should not be. In each case, the central computer system 130 may communicate an alert to a store worker to attend to the zone or area.

The baseline thermal profile may be determined or obtained at a previous time based on validation and quality control studies. In some embodiments, a baseline thermal image for a given zone or area may be obtained by machine learning. For example, a given zone of the retail facility may contain an HVAC unit. The central computer system 130 may learn over time the normal temperature cycle fluctuations of the HVAC unit for a given time period, resulting in a tolerance thermal range for the zone or area. In some embodiments, a baseline thermal image for a given zone or area may be based on confirmed compliance, where a tolerance range is previously defined for the unit. In some embodiments, the baseline thermal profile may be the most recent thermal image obtained by the thermal sensor during the previous monitoring cycle. In some embodiments, the expected thermal profile for a given zone may change based on the time of day or day of the week. Additionally or alternatively, other parameters may be used to determine a baseline thermal profile, such as, but not limited to, outside temperature data, weather data, number of employees in the portion of the retail facility, expected number of customers present, HVAC data, and retail stock data, or combinations thereof. These parameters may be obtained in real time or may be obtained previously and stored in a database coupled to the central computer system 130, such as database 140. In some embodiments, outside temperature data may be obtained from one or more temperature sensors located outside of the retail facility that are configured to transmit external temperature data to central computer system 130 via a wired and/or wireless signal connection. In some embodiments, real time weather data may be obtained by the central computer system 130 from commercial and/or governmental weather sources and/or web sites.

In embodiments where occupancy is estimated, the known thermal profiles may correlate to occupancy based on an expected increase in temperature associated with each additional customer in the portion of the retail facility. For example, when customers congregate in a specific area of the retail facility, the heat generated by each customer may raise the temperature in the area above an expected temperature for the area. In some cases, the expected temperature contribution for each expected customer may be used to calculate a known thermal profile relating to estimated occupancy. In some cases, the known thermal profiles correlating to occupancy may be based on machine learning or by confirmed compliance, as described above.

In embodiments where occupancy is estimated, the central computer system 130 may be further configured to estimate the dwell time of customers in the retail facility by determining the duration that the estimated occupancy of the portion of the retail facility remains above the expected occupancy. In some embodiments, the system may estimate the dwell time of customers in the retail facility by determining the duration that the estimated occupancy of the portion of the retail facility remains above the predetermined value. When the dwell time is longer than a specific duration, the system may alert a worker to attend to the portion of the retail facility. In some cases, a higher than expected dwell time may correlate to a low level of service such that the dwell time is inversely proportional to the level of service in the portion of the retail facility.

In some embodiments, the central computer system 130 may be configured to automatically generate one or more alerts and/or tasks based on estimated occupancy and/or estimated dwell time for the portion of the retail facility. For example, the central computer system 130 may determine areas with a higher than expected occupancy and/or dwell time as described above and may instruct a motorized unit and/or a store worker to survey the area to ensure the area is clean, sufficiently stocked, and/or sufficiently staffed. In another example, the central computer system 130 may determine one or more areas with unusually low occupancy and/or dwell time and instruct a motorized unit and/or a store worker to investigate for the presence of spills or other types of obstructions. In some embodiments, the central computer system 130 may send an alert to a handheld and/or mobile device configured to be carried by a worker.

In some embodiments, the central computer system 130 may compare estimated occupancy and/or dwell time with point of sale data to determine if the estimated occupancy and/or dwell time is justified by the point of sale data. In some embodiments, the point of sale data may be obtained from one or more point of sale units coupled to, and configured to transmit data to, the central computer system 130. Point of sale data may include all data relating to customer purchase and return transactions in the retail facility. Examples of point of sale units include, but are not limited to, staffed checkout terminals and self-service kiosks. Point of sale data may also be stored in, and obtained from, a database, such as database 140.

In embodiments where temperature control unit efficiency is estimated, the known thermal profiles may correlate to unit efficiency based on expected increases in temperature above a normal operating temperature of the exterior of the temperature control unit efficiency. In some embodiments, the normal operating temperature may be the baseline temperature. Often times, temperature control units, such as, for example, coolers, refrigerators, and HVAC units, experience a decrease in efficiency prior to failure. This decrease in efficiency may cause an increase in temperature above a normal operating temperature directly surrounding the temperature control unit as the unit tries to maintain its programmed temperature. For example, a refrigerator that is approaching failure and/or is losing cooling efficiency may begin to emit additional heat from the exterior of the unit above the normal operating temperature due to the increased work necessary to maintain the required cold temperature inside the refrigerator. In some embodiments, the normal operating temperature may be the baseline temperature.

One or more thermal sensors 120 positioned near the outside of the temperature control unit may detect this increase in temperature from the temperature control unit and may transmit a thermal image and/or thermal data relating to the temperature control unit to the central computer system 130. The central computer system 130 may then compare the obtained thermal image to known thermal profiles as described above to determine whether the temperature control unit is losing efficiency and/or is approaching failure. In some embodiments, the temperature control unit may be determined to be losing efficiency and/or approaching failure when the thermal image indicates a temperature that is higher than one or more predetermined threshold temperatures.

Temperature control units such as food coolers and warming units may be similarly monitored to determine operational fitness based on the temperature emitted from the cooler or warming unit. For example, food coolers (both open and closed) may generally have an external temperature that is lower than an ambient temperature, while warming units, such as warming ovens, may generally have an external temperature that is higher than an ambient temperature. One or more thermal sensors 120 positioned near the unit may identify a temperature increase of the cooler or a temperature decrease of the warming unit and may transmit a thermal image and/or thermal data relating to the cooler or warming unit to the central computer system 130. The central computer system 130 may then compare the obtained thermal image to known thermal profiles as described above to determine whether the cooling or warming unit is cooling or warming properly for the perishable products contained therein.

In some embodiments, the central computer system 130 may be configured to automatically generate one or more alerts to alert or notify a store worker that a particular temperature control unit is losing efficiency, is approaching failure, and/or may be otherwise compromised by not cooling or warming properly. For example, the central computer system 130 may determine that a particular temperature control unit is losing efficiency, is approaching failure, and/or may be otherwise compromised by not cooling or warming properly and may instruct a motorized unit and/or a store worker to inspect the temperature control unit. In some embodiments, the central computer system 130 may send an alert to a handheld and/or mobile device configured to be carried by a worker. In some embodiments, the central computer system 130 may automatically create a task in a task scheduling system instructing a worker to inspect the temperature control unit.

In embodiments where temperature-sensitive retail items are detected in the retail facility, the known thermal profiles may correlate to expected temperatures and/or thermal images for various temperature-sensitive retail items such as, for example, refrigerated products and/or a heated cafeteria-style foods item. For example, when a cold-temperature item, such as, for example, a carton of frozen ice cream has been abandoned in an ambient-temperature area of the retail facility, such as, for example, on a shelf or left in a shopping cart in an aisle, one or more thermal sensors 120 may detect a temperature that is lower than an expected temperature for that portion of the retail facility, which may be a baseline temperature as described above. The central computer system 130 may compare a thermal image and/or thermal data obtained from the thermal sensor 120 to the known thermal profiles associated with various temperature-sensitive retail items and may determine that the retail item is a temperature-sensitive item that has been abandoned. In some embodiments, the central computer system 130 may be configured to determine a location of the abandoned temperature-sensitive retail item. In some embodiments, the central computer system 130 may be further configured to estimate the dwell time of the abandoned temperature-sensitive retail item.

Similarly, when a warm-temperature item, such as, for example, a roasted chicken dinner has been abandoned in an ambient-temperature area of the retail facility, such as, for example, on a shelf or left in a shopping cart, one or more thermal sensors 120 may detect a temperature that is higher than an expected temperature for that portion of the retail facility, which may be a baseline temperature as described above. The central computer system 130 may compare a thermal image and/or thermal data obtained from the thermal sensor 120 to the known thermal profiles associated with various temperature-sensitive retail items and may determine that the retail item is a temperature-sensitive item that has been abandoned. In some embodiments, the central computer system 130 may be configured to determine a location of abandoned temperature-sensitive retail item.

In some embodiments, the central computer system 130 may be configured to automatically generate one or more alerts and/or tasks based on a determination that a temperature-sensitive item has been abandoned in an ambient-temperature portion of the retail facility and/or based on a determination that the temperature-sensitive item has remained in the ambient-temperature area of the retail facility for greater than a predetermined duration. For example, the central computer system 130 may instruct a motorized unit and/or a store worker to survey the area to retrieve and assess the temperature-sensitive item. In some embodiments, the central computer system 130 may send an alert to a handheld and/or mobile device configured to be carried by a worker.

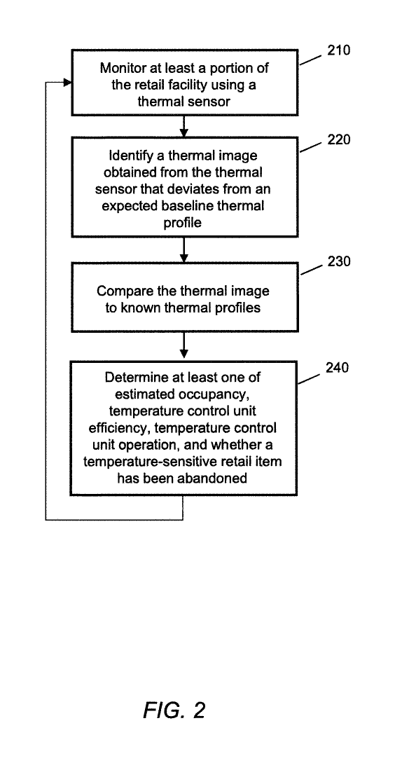

Referring now to FIG. 2, a method for thermal monitoring a retail facility is shown. Generally, the method shown in FIG. 2 may be implemented with a processor based device such as a control circuit, a central processor, and the like. In some embodiments, the method shown in FIG. 2 may be implemented with the central computer system 130 in FIG. 1.

In step 210, the system monitors at least a portion of the retail facility using a thermal sensor. In some embodiments, the system may continuously monitor at least a portion of the retail facility such that a control circuit, such as central computer system 130 described with reference to FIG. 1, obtains thermal images and/or thermal data from the thermal sensor for processing.

In some embodiments, the thermal sensors may comprise the thermal sensors 120 described with reference to FIG. 1. The thermal sensor may generally be configured to detect a heat source in the retail facility and transmit a thermal image and/or thermal data to a central computer system. The thermal sensor may be any sensor that is suitable for detecting a heat source. In some embodiments, the thermal sensor may be an infrared sensor. The infrared sensor may be, for example, a passive infrared sensor, a thermal imager, or any other sensor that detects thermal radiation, electromagnetic radiation, infrared energy, or any other type of energy. In some embodiments, the thermal sensor may be a thermal sensor array. In some embodiments, the thermal sensor may comprise an infrared camera, such as, for example, a forward looking infrared (FLIR) camera. In some embodiments, the system may comprise a plurality of thermal sensors and/or thermal sensor arrays be positioned throughout a retail facility.

In some embodiments, thermal sensor may be a stationary thermal sensor installed in the retail facility. For example, the thermal sensor may be installed in the celling, pillars, beams, modules, display shelves, etc. of a retail facility. In some embodiments, the thermal sensor may be positioned at an end of an aisle in the retail facility. In some embodiments, the thermal sensor may be a directional sensor in which the sensor has a specific field of view. The image obtained from each sensor having a specific field of view may cover a zone or area of the retail facility, or may cover multiple zones or areas of the retail facility. The directional thermal sensor may be coupled to a rotation apparatus configured to rotate the thermal sensor, allowing rotation of the field of view of the thermal sensor. In this configuration, thermal updates for a specific location are provided at each rotation past the specific area, zone, or location. In some embodiments, the thermal sensor may be a stationary sensor and have a wide-angle view, which may allow continuous, real-time monitoring.

In step 220, the system identifies a thermal image obtained from the thermal sensor that deviates from an expected baseline thermal profile for the area or zone in the field of view of the sensor. The expected baseline thermal profile may be determined or obtained at a previous time based on validation and quality control studies and/or may be the most recent thermal profile obtained from the thermal sensor during the previous cycle. In some embodiments, a baseline thermal image for a given zone or area may be obtained by machine learning, as described above. In some embodiments, a baseline thermal image for a given zone or area may be based on confirmed compliance, where a tolerance range is previously defined, as also described above. Additionally or alternatively, other parameters may be used to determine a baseline thermal profile, such as, but not limited to, outside temperature data, weather data, number of employees in the portion of the retail facility, expected number of customers present, HVAC data, and retail stock data, or combinations thereof. These parameters may be obtained in real time or may be obtained previously and stored in a database coupled to the central computer system, such as database 140 in FIG. 1. In some embodiments, outside temperature data may be obtained from one or more temperature sensors located outside of the retail facility that are configured to transmit external temperature data to the central computer system via a wired and/or wireless signal connection. In some embodiments, real time weather data may be obtained by the central computer system from commercial and/or governmental weather sources and/or websites. In some embodiments, the baseline temperature may be calculated prior immediately prior to step 210.

If the system identifies a thermal image that deviates from the expected baseline thermal profile in step 220, the system compares the thermal image to known thermal profiles, as illustrated in step 230. The known thermal profiles may correlate to estimated occupancy, temperature control unit operation, temperature control unit efficiency, and data relating to retail stock such as, for example, temperature-sensitive retail items. In step 240, the system matches the obtained thermal image to a known thermal profile to determine at least one of estimated occupancy, temperature control unit efficiency, temperature control unit operation, and whether a temperature-sensitive retail item has been abandoned.

In embodiments where occupancy is estimated, the known thermal profiles may correlate to occupancy based on an expected increase in temperature associated with each additional customer in the portion of the retail facility. For example, when customers congregate in a specific area of the retail facility, the heat generated by each customer may raise the temperature in the area above an expected temperature for the area. In such a case, the system may compare the temperature increase to known thermal profiles to determine estimated occupancy. In some embodiments, the expected temperature contribution for each expected customer may be used to calculate a known thermal profile relating to estimated occupancy. In some cases, the known thermal profiles correlating to occupancy may be based on machine learning or by confirmed compliance, as described above.

If the estimated occupancy is higher than a predetermined value related to an expected number of customers based on, for example, the time of day and the location of the area in the retail facility, the system may alert a worker to attend to the portion of the retail facility to assess the reason for the increased occupancy. For example, there may be a shortage of stock in the specific area, or there may be a shortage of workers available to assist customers in the specific area, causing customers to linger and accumulate in the area. Increased occupancy in a specific area might also require a worker to attend to the area to clean and/or straighten up the area, which may have become untidy due to the increased customer activity.

The system may also be configured to estimate the dwell time of the customers by determining the duration that the estimated occupancy remains above the predetermined value. If the estimated occupancy endures for a duration longer than a predetermined duration, the system may alert a worker to attend to the portion of the retail facility, as described above.

In some cases, the duration that the estimated occupancy of the portion of the retail facility remains above the predetermined value may correlate to a level of service. In some cases, the duration that the estimated occupancy of the portion of the retail facility remains above the predetermined value may be inversely proportional to the level of service in the portion of the retail facility. For example, the duration that an unexpectedly high number of customers lingers in an area of the retail facility may indicate a sub-standard level of service in that area of the retail facility. In such a case, one or more workers may be alerted and/or summoned to the area of the retail facility to assist the additional customers.

In some embodiments, the system may be configured to automatically generate one or more alerts and/or tasks based on estimated occupancy and/or estimated dwell time for the portion of the retail facility. For example, the system may determine areas with a higher than expected occupancy and/or dwell time as described above and may instruct a motorized unit and/or a store worker to survey the area to ensure the area is clean, sufficiently stocked, and/or sufficiently staffed. In another example, the system may determine one or more areas with unusually low occupancy and/or dwell time and instruct a motorized unit and/or a store worker to investigate for the presence of spills or other types of obstructions. In some embodiments, the system may send an alert to a handheld and/or mobile device configured to be carried by a worker.

In some embodiments, the system may compare estimated occupancy and/or dwell time with point of sale data to determine if the estimated occupancy and/or dwell time is justified by the point of sale data. Point of sale data may include all data relating to customer purchase and return transactions in the retail facility. In some embodiments, the point of sale data may be obtained from one or more point of sale units coupled to, and configured to transmit data to, the system. Examples of point of sale units include, but are not limited to, staffed checkout terminals and self-service kiosks. Point of sale data may also be stored in, and obtained from, a database, such as database 140 in FIG. 1.

The system may utilize the point of sale data to determine whether an increased occupancy is justified based on sales of items in the area of the retail facility experiencing the increased occupancy. The system may be configured to compare the estimated occupancy of the portion of the retail facility to the point of sale data to determine if the estimated occupancy of the portion of the retail facility is justified by the point of sale data. The estimated occupancy may be deemed to be justified when the point of sale data is higher than a predetermined value. For example, if the estimated occupancy in a portion of the retail facility is especially high compared to an expected/predetermined value as described above, and the point of sale data indicates a correspondingly high level of sales for retail items located in that portion of the retail facility that has the high estimated occupancy, the estimated occupancy may be deemed to be justified. In such a case, a marketing person may be notified of this data. Conversely, if the point of sale data indicates relatively low sales of items in an area of the retail facility experiencing especially high estimated occupancy, the estimated occupancy may be deemed to be not justified. In such a case, a worker may be alerted to attend to the area of the retail facility to determine a reason for unexpectedly high occupancy.

In embodiments where temperature control unit efficiency is estimated, the known thermal profiles may correlate to temperature control unit efficiency based on expected increases in temperature above a normal operating temperature of the exterior of the temperature control unit. In some embodiments, the normal operating temperature may be the baseline temperature as described above. The may system obtain a thermal image and/or thermal data for the temperature control unit obtained from one or more thermal sensors positioned near the outside of the temperature control unit, and may compare the thermal image to known thermal profiles to determine that the temperature control unit is losing efficiency, is approaching failure, and/or is otherwise compromised.

Often times temperature control units, such as, for example, coolers, refrigerators, and HVAC units experience a decrease in efficiency prior to failure. This decrease in efficiency may cause an increase in temperature above a normal operating temperature directly surrounding the temperature control unit as the unit tries to maintain its programmed temperature. For example, a refrigerator that is approaching failure and/or is losing cooling efficiency may begin to emit additional heat from the exterior of the unit above the normal operating temperature due to the increased work necessary to maintain the required cold temperature inside the refrigerator.

Temperature control units such as food coolers and warming units may be similarly monitored to determine operational fitness based on the temperature emitted from the cooler or warming unit. For example, food coolers (both open and closed) may generally have an external temperature that is lower than an ambient temperature, while warming units, such as a warming over, may generally have an external temperature that is higher than an ambient temperature. One or more thermal sensors 120 positioned near the unit may identify a temperature increase of the cooler or a temperature decrease of the warming unit and may transmit a thermal image and/or thermal data relating to the cooler or warming unit to the central computer system 130. The central computer system 130 may then compare the obtained thermal image to known thermal profiles as described above to determine whether the cooler or warming unit is cooler or warming properly for the perishable products contained therein or may be otherwise compromised.

In some embodiments, the system may automatically generate one or more alerts to alert or notify a store worker that a particular temperature control unit is losing efficiency, is approaching failure, and/or may be otherwise compromised by not cooling or warming properly. For example, the system may determine that a particular temperature control unit is losing efficiency, is approaching failure, and/or may be otherwise compromised by not cooling or warming properly, and may instruct a motorized unit and/or a store worker to inspect the temperature control unit. In some embodiments, the system may send an alert to a handheld and/or mobile device configured to be carried by a worker. In some embodiments, the system may automatically create a task in a task scheduling system instructing a worker to inspect the temperature control unit.

In embodiments where temperature-sensitive retail items are detected in the retail facility, the known thermal profiles may correlate to expected temperatures and/or thermal images for various temperature-sensitive retail items such as, for example, refrigerated products and/or a heated cafeteria-style foods item. For example, when a cold-temperature item, such as, for example, a carton of frozen ice cream has been abandoned in an ambient-temperature area of the retail facility, such as, for example, on a shelf or left in a shopping cart in an aisle, one or more thermal sensors may detect a temperature that is lower than an expected temperature for that portion of the retail facility, which may be a baseline temperature, as described above. The system may compare a thermal image and/or thermal data obtained from the thermal sensor to the known thermal profiles associated with various temperature-sensitive retail items and may determine that the retail item is a temperature-sensitive item that has been abandoned. In some embodiments, the system may be configured to determine a location of the abandoned temperature-sensitive retail item. In some embodiments, the system may be further configured to estimate the dwell time of the abandoned temperature-sensitive retail item.

Similarly, when a warm-temperature item, such as, for example, a roasted chicken dinner has been abandoned in an ambient-temperature area of the retail facility, such as, for example, on a shelf or left in a shopping cart, one or more thermal sensors may detect a temperature that is higher than an expected temperature for that portion of the retail facility, which may be a baseline temperature, as described above. The system may compare a thermal image and/or thermal data obtained from the thermal sensor to the known thermal profiles associated with various temperature-sensitive retail items and may determine that the retail item is a temperature-sensitive item that has been abandoned. In some embodiments, the system is configured to determine a location of the abandoned temperature-sensitive retail item.

In some embodiments, the system may be configured to automatically generate one or more alerts and/or tasks based on a determination that a temperature-sensitive item has been abandoned in an ambient-temperature portion of the retail facility and/or based on a determination that the temperature-sensitive item has remained in the ambient-temperature area of the retail facility for greater than a predetermined duration. For example, the system may instruct a motorized unit and/or a store worker to survey the area to retrieve and assess the temperature-sensitive item. In some embodiments, the system may send an alert to a handheld and/or mobile device configured to be carried by a worker.

After step 240, steps 210-240 may be repeated to allow the system to continuously thermally monitor the portion of the retail facility.

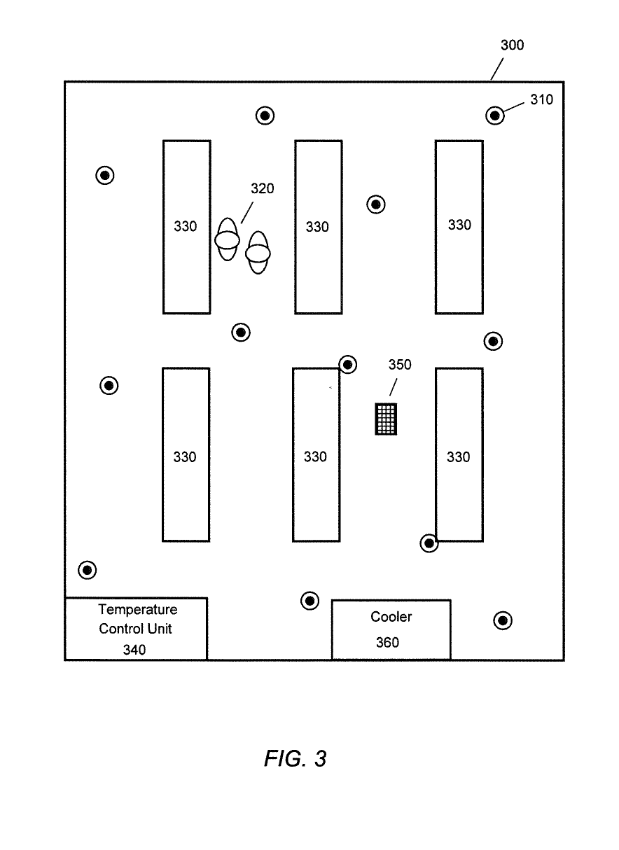

Next referring to FIG. 3, an illustration of a retail facility according to some embodiments is shown. The retail facility 300 may comprise a plurality of display modules 330 (which may also be referred to as modular or modular units), a plurality of thermal sensors 310 positioned throughout the retail facility, one or more customers 320, temperature control unit 340, shopping cart 350, and cooler 360.

The system may monitor various areas of the retail facility using thermal sensors 310, which may be configured to detect a heat source in the retail facility and to transmit a thermal image and/or thermal data to a central computer system for processing. For example, the thermal sensors 310 may detect heat emitted by customers 320 present in a portion of the retail facility, heat emitted by temperature control unit 340, and changes in temperature due to warm or cold retail items being abandoned or left in an incompatible portion of the retail facility, such as, for example, in a shopping cart 350 or on a shelf in display module 330. The system may also detect a change in the temperature emitted by the cooler 360, which may contain perishable, cold-temperature products, such as dairy products, which may indicate a possible malfunction of the cooling system. The thermal sensors 310 may be any sensor that is suitable for detecting a heat source. In some embodiments, the thermal sensors 310 may be infrared sensors. The infrared sensors may be, for example, a passive infrared sensors, thermal imagers, or any other sensors that detect thermal radiation, electromagnetic radiation, infrared energy, or any other type of energy. In some embodiments, the thermal sensor may comprise an infrared camera, such as, for example, a forward looking infrared (FLIR) camera. In some embodiments, the thermal sensors 310 may be a thermal sensor array.

In some embodiments, thermal sensors 310 may be stationary thermal sensors installed in the retail facility. For example, the thermal sensors 310 may be installed in the celling, pillars, beams, modules, display shelves, etc. of a retail facility. In some embodiments, thermal sensors 310 may be positioned at an end of an aisle in the retail facility. In some embodiments, the thermal sensors 310 may be directional sensors in which the sensor has a specific field of view. The image obtained from each sensor having a specific field of view may cover a zone or area of the retail facility, or may cover multiple zones or areas of the retail facility. The directional thermal sensor may be coupled to a rotation apparatus configured to rotate the thermal sensor, allowing rotation of the field of view of the thermal sensor. In this configuration, thermal updates for a specific location are provided at each rotation past the specific location. In some embodiments, the thermal sensors 310 may be a stationary sensor and have a wide-angle view, which may allow continuous, real-time monitoring.

As the system monitors various areas of the retail facility 300, the system may be configured to identify a thermal image obtained from the thermal sensors 310 that deviates from an expected baseline thermal profile for the portion of the retail facility. The system may be configured to compare the thermal image to known thermal profiles to determine at least one of estimated occupancy, temperature control unit efficiency, temperature control unit operation, and whether a temperature-sensitive retail item has been abandoned.

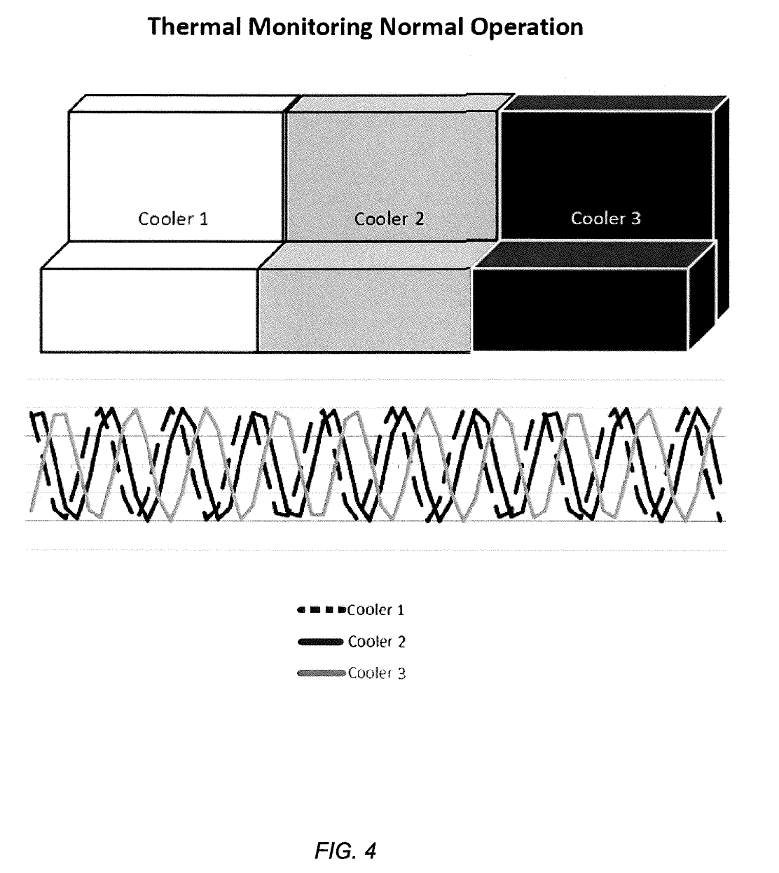

FIGS. 4 to 8 illustrate examples of thermal monitoring of a cooler system which may contain cold-temperature food products, such as dairy products or frozen products, in a retail facility. The coolers may be open coolers or closed coolers, and may also be freezers. The coolers in FIGS. 4 to 8 (Cooler 1, Cooler 1, and Cooler 3) may be arranged side by side in the retail facility, with one or more thermal sensors directed toward the coolers to thermally monitor the coolers and the surrounding area.

FIG. 4 illustrates normal operation of the Coolers 1, 2, and 3. Each of the three coolers has a similar cooling cycle over a period of time, illustrated by the overlapping sine waves of temperature readings shown below the line of coolers. As illustrated in FIG. 4, each cooler may have a different temperature within a range of acceptable temperatures for the cycle at a given moment in time. The thermal profiles illustrated in FIG. 4, being within an acceptable temperature range with no significant deviations, may form a baseline thermal profile of an acceptable temperature range for the coolers, such that thermal profiles that deviate from this baseline profile may indicate a loss of function or other unexpected event requiring attention from a store worker.

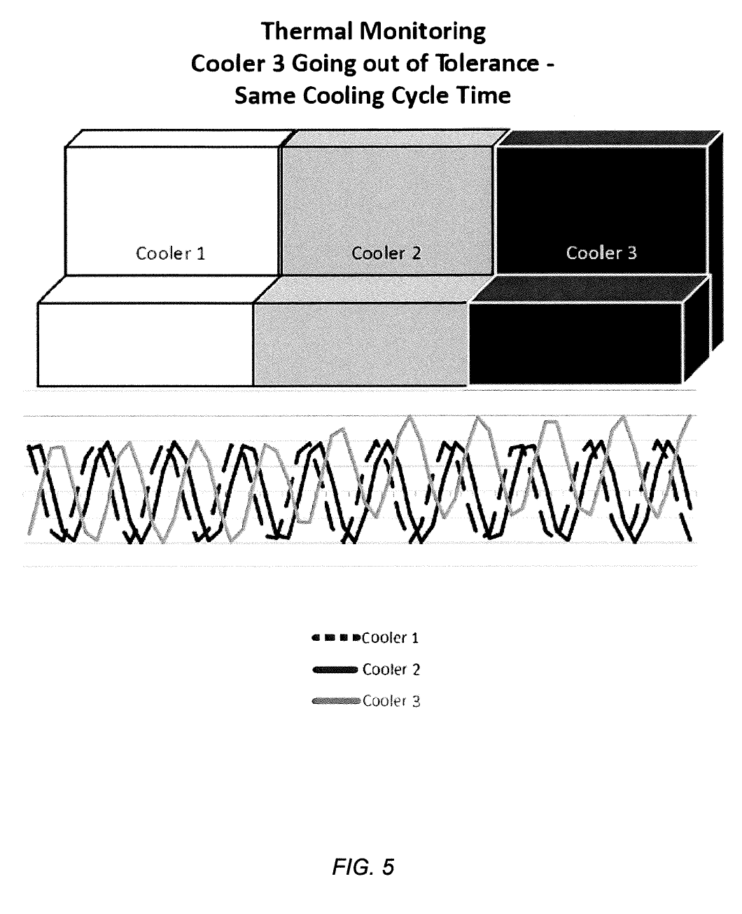

FIG. 5 illustrates a scenario where Cooler 3 has a thermal profile that deviates from the baseline thermal profile illustrated in FIG. 4 in that the upper temperature range for Cooler 3's cycle gradually increases above the tolerance level discussed with reference to FIG. 4. Potential causes for the thermal profile of Cooler 3 in FIG. 5 may include, for example, loss of cooling function, or positioning or functionality problems with a temperature probe in the cooler. In any case, such a deviation may cause an alert to be communicated to a store worker to investigate the cause of the deviation.

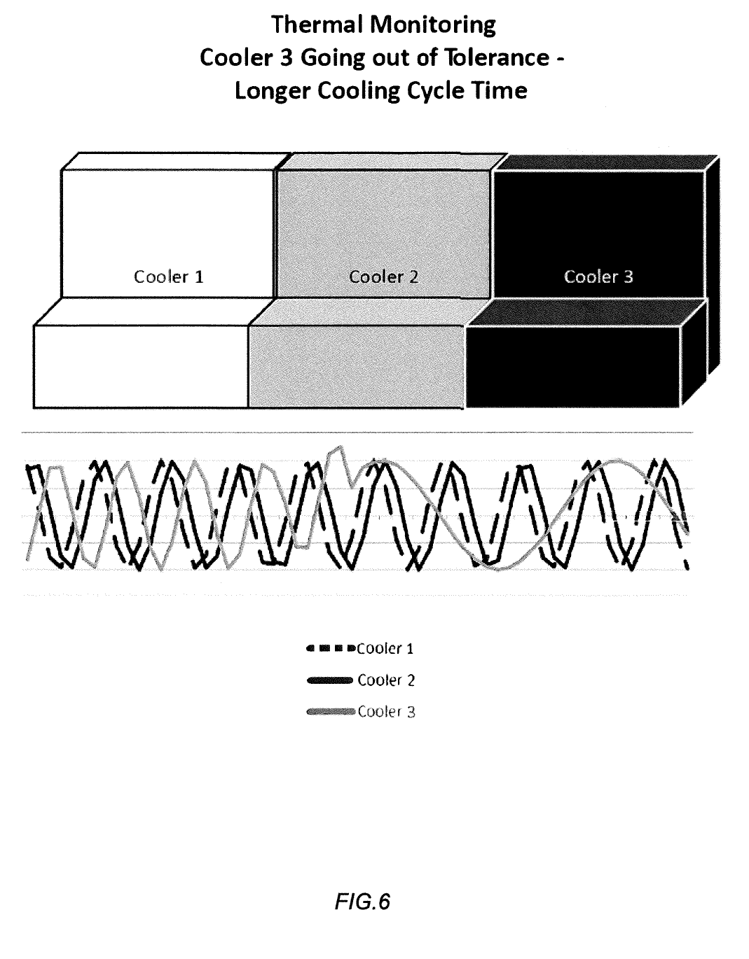

FIG. 6 also illustrates a scenario where Cooler 3 has a thermal profile that deviates from the baseline thermal profile illustrated in FIG. 4 in that the upper temperature range for Cooler 3's cycle is above the tolerance level discussed with reference to FIG. 4. The thermal profile for Cooler 3 in FIG. 6 also illustrates a longer cooling cycle time than Coolers 1 and 2, and also a longer cycle time that than Cooler 3 in FIGS. 4 and 5. Potential causes for the thermal profile of Cooler 3 in FIG. 6 may include, for example, problems with the thermostat or PID controller, low coolant in the compressor, or over packing of the cooler with product. In any case, such a deviation may cause an alert to be communicated to a store worker to investigate the cause of the deviation.

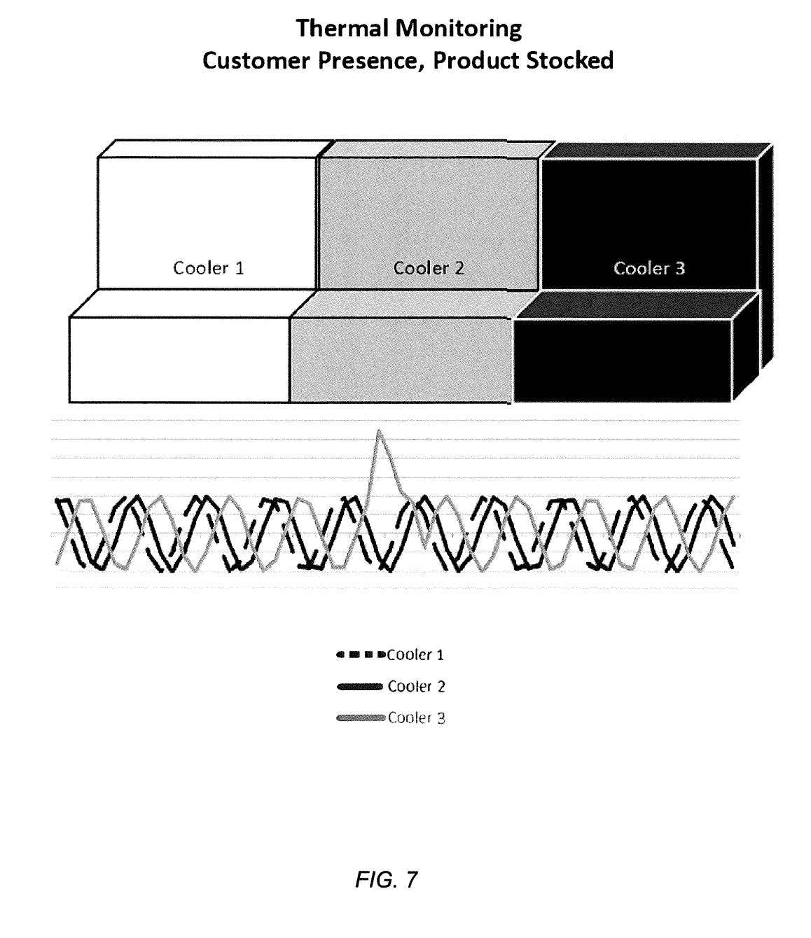

FIG. 7 illustrates a scenario where Cooler 3 generally has a similar thermal profile to Coolers 1 and 2, and within the acceptable range illustrated in FIG. 4, except for a temperature spike incident illustrated by the spike in the sine wave for Cooler 3. Such a spike may be caused, for example, by an increase in temperature from a customer or store worker standing in front of the cooler. Such a temporary spike in temperature may also be caused, for example, when a higher temperature product, such as stock from an ambient temperature area of the store, is introduced into the cooler. The spike in temperature may also be caused by the cooler door being left open longer than is usually expected. In some cases, such a spike may cause an alert to be communicated to a store worker to investigate the cause of the deviation. In other cases, the system may be configured to tolerate such temporary spikes. This data may also be useful in tracking customers and customer behavior in various areas of the facility.

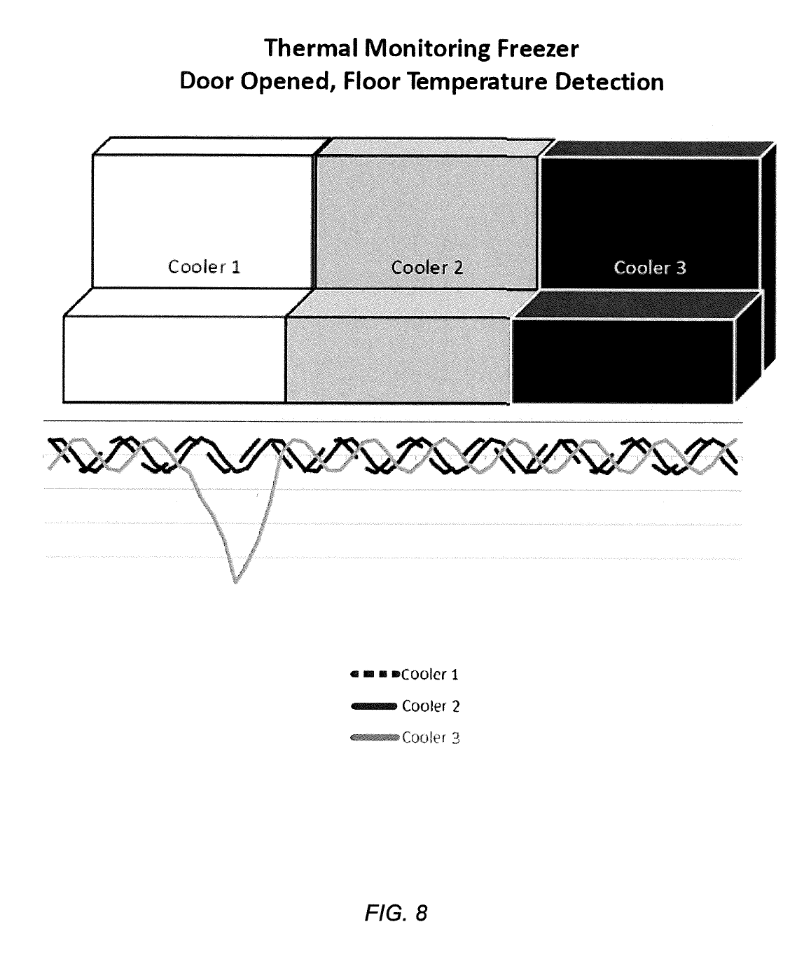

FIG. 8 illustrates a scenario where the floor in front of Coolers 1, 2, and 3, which are arranged side-by-side in the retail facility, is thermally monitored for changes in temperature. As illustrated in FIG. 8, the floor in front of Cooler 3 has a similar thermal profile to the floor in front of Coolers 1 and 2 except for a sharp temperature decrease incident illustrated by the negative spike in the sine wave for Cooler 3. This sharp temperature decrease may be caused, for example, by the door of Cooler 3 being left open, allowing the floor in front of Cooler 3 to become significantly colder. Such a sharp temperature decrease may be also caused, for example, by a frozen item, such a pizza box or a carton of ice cream being left on the floor in front of Cooler 3, or even a spill on the floor in front of Cooler 3. In any case, such a deviation may cause an alert to be communicated to a store worker to investigate the cause of the deviation.

In one embodiment, a system for thermal monitoring in a retail facility comprises: a thermal sensor positioned in a predetermined location of a portion of the retail facility; a database for storing thermal images and thermal data obtained from the thermal sensor and known thermal profiles correlating to baseline conditions, occupancy, temperature control unit efficiency and operation, and retail stock; and a control circuit coupled to the thermal sensor and the database, the control circuit configured to: identify a thermal image obtained from the thermal sensor that deviates from an expected baseline thermal profile for the portion of the retail facility; and compare the thermal image to the known thermal profiles to determine at least one of estimated occupancy, temperature control unit efficiency, temperature control unit operation, and whether a temperature-sensitive retail item has been abandoned.

In one embodiment, a method of thermal monitoring in a retail facility comprises: monitoring at least a portion of the retail facility using a thermal sensor; identifying a thermal image obtained from the thermal sensor that deviates from an expected baseline thermal profile for the portion of the retail facility; and comparing the thermal image to the known thermal profiles to determine at least one of estimated occupancy, temperature control unit efficiency, temperature control unit operation, and whether a temperature-sensitive retail item has been abandoned.

It should be understood that each of the components of the system described herein may be in communication with one another using any conventional communications protocol, including wireless communication protocols. Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for thermal monitoring in a retail facility, the system comprising:
a thermal sensor positioned in a predetermined location of a portion of the retail facility;
a database for storing thermal images and thermal data obtained from the thermal sensor and known thermal profiles correlating to baseline conditions, occupancy, temperature control unit efficiency, temperature control unit operation, and retail stock; and
a control circuit coupled to the thermal sensor and the database, the control circuit configured to:
identify a thermal image obtained from the thermal sensor that deviates from an expected baseline thermal profile for the portion of the retail facility; and
compare the thermal image to the known thermal profiles to determine at least one of an estimated occupancy, temperature control unit efficiency, temperature control unit operation, and whether a temperature-sensitive retail item has been abandoned.

2. The system of claim 1, wherein the thermal sensor is an infrared sensor positioned at an end of an aisle of the retail facility.

3. The system of claim 1, wherein the thermal sensor is an infrared sensor positioned above the portion of the retail facility such that the infrared sensor is inside the retail facility.

4. The system of claim 1, wherein the control circuit is further configured to alert a worker when a temperature control unit is determined to be failing, wherein the temperature control unit is determined to be failing when the thermal image comprises an image of the temperature control unit and the thermal image indicates a warmer temperature than expected based on a known thermal profile of the temperature control unit.

5. The system of claim 1, wherein the control circuit is further configured to alert a worker when a temperature-sensitive retail item is determined to be abandoned, wherein the temperature-sensitive retail item is determined to be abandoned when the thermal image indicates a colder or warmer temperature than expected based on the baseline thermal profile of the portion of the retail facility.

6. The system of claim 1, wherein the database stores point of sale data for the retail facility, and the control circuit is further configured to compare the estimated occupancy of the portion of the retail facility to the point of sale data stored in the database to determine if the estimated occupancy of the portion of the retail facility is justified by the point of sale data, the estimated occupancy being justified when the point of sale data is higher than a predetermined value.

7. The system of claim 6, wherein if the estimated occupancy of the portion of the retail facility is not justified by the point of sale data, a worker is alerted to attend to the portion of the retail facility, or if the estimated occupancy of the portion of the retail facility is justified by the point of sale data, a marketing associate is alerted.

8. The system of claim 1, further comprising:
one or more point of sale units coupled to the control circuit such that the one or more point of sale units transmit point of sale data for the retail facility to the control circuit,
wherein the control circuit is further configured to compare the estimated occupancy of the portion of the retail facility to the point of sale data to determine if the estimated occupancy of the portion of the retail facility is justified by the point of sale data, the estimated occupancy being justified when the point of sale data is higher than a predetermined value.

9. The system of claim 8, wherein if the estimated occupancy of the portion of the retail facility is not justified by the point of sale data, a worker is alerted to attend to the portion of the retail facility, or if the estimated occupancy of the portion of the retail facility is justified by the point of sale data, a marketing associate is alerted.

10. The system of claim 1, wherein the control circuit is further configured to determine a duration that the estimated occupancy of the portion of the retail facility remains above a predetermined value, and to alert a worker to attend to the portion of the retail facility when the estimated occupancy of the portion of the retail facility remains above the predetermined value for more than a predetermined duration.

11. The system of claim 10, wherein the duration that the estimated occupancy of the portion of the retail facility remains above the predetermined value correlates to a level of service such that the duration that the estimated occupancy of the portion of the retail facility remains above the predetermined value is inversely proportional to the level of service in the portion of the retail facility.

12. A method of thermal monitoring in a retail facility, the method comprising:
monitoring at least a portion of the retail facility using a thermal sensor;
identifying a thermal image obtained from the thermal sensor that deviates from an expected baseline thermal profile for the portion of the retail facility; and
comparing the thermal image to the known thermal profiles to determine at least one of an estimated occupancy, temperature control unit efficiency, temperature control unit operation, and whether a temperature-sensitive retail item has been abandoned.

13. The method of claim 12, wherein the thermal sensor from which the thermal image is obtained is an infrared sensor positioned at an end of an aisle of the retail facility.

14. The method of claim 12, wherein the thermal sensor from which the thermal image is obtained is an infrared sensor positioned above the portion of the retail facility such that the infrared sensor is inside the retail facility.

15. The method of claim 12, further comprising:
alerting a worker when a temperature control unit is determined to be failing,
wherein the temperature control unit is determined to be failing when the thermal image comprises an image of the temperature control unit and the thermal image indicates a warmer temperature than expected based on a known thermal profile of the temperature control unit.

16. The method of claim 12, further comprising:
alerting a worker when a temperature-sensitive retail item is determined to be abandoned,
wherein the temperature-sensitive retail item is determined to be abandoned when the thermal image indicates a colder or warmer temperature than expected based on the baseline thermal profile of the portion of the retail facility.

17. The method of claim 12, wherein the estimated occupancy of the portion of the retail facility is compared to point of sale data to determine if the estimated occupancy of the portion of the retail facility is justified by the point of sale data, the estimated occupancy being justified when the point of sale data is higher than a predetermined value.

18. The method of claim 17, wherein if the estimated occupancy of the portion of the retail facility is not justified by the point of sale data, alerting a worker to attend to the portion of the retail facility, or if the estimated occupancy of the portion of the retail facility is justified by the point of sale data, alerting a marketing associate.

19. The method of claim 12, further comprising determining a duration that the estimated occupancy of the portion of the retail facility remains above a predetermined value, and alerting a worker to attend to the portion of the retail facility when the estimated occupancy of the portion of the retail facility remains above the predetermined value for more than a predetermined duration.

20. The system of claim 19, wherein the duration that the estimated occupancy of the portion of the retail facility remains above the predetermined value correlates to a level of service such that the duration that the estimated occupancy of the portion of the retail facility remains above the predetermined value is inversely proportional to the level of service in the portion of the retail facility.
